(19) United States
(12) Patent Application Publication
(10) Pub. No.: US 2004/0101620 A1
(43) Pub. Date: May 27, 2004

(54) Method for aluminum metalization of ceramics for power electronics applications

(76) Inventors: Alaa A. Elmoursi, Troy, MI (US); Donald T. Morelli, White Lake, MI (US); Nilesh B. Patel, Macomb Township, MI (US)

Correspondence Address: SCOTT A. MCBAIN, DELPHI TECHNOLOGIES, INC., Legal Staff, Mail Code: 480-410-202, P.O. Box 5052, Troy, MI, 48007-5052, US

(21) Appl. No.: 10/302,749

(22) Filed: Nov. 22, 2002

(51) Int. Cl. B05D 1/02; B05D 1/12

(52) U.S. Cl. 427/180; 427/421

(57) ABSTRACT

A method is disclosed for the aluminum metalization of ceramics using a kinetic spray system. The method is rapid, does not require any surface preparation of the ceramic substrate, and produces a coating having properties similar to bulk aluminum. The method permits aluminum coatings of from microns to centimeters in thickness. The method further more enables one to quickly apply copper or copper alloys to the aluminum metalization to provide for soldering pads to attach other components. The method finds special application in the area of high powered electronics.

### TECHNICAL FIELD

The present invention is directed toward a method for metalization of ceramics, and more particularly, toward a method for metalization of ceramics using kinetically sprayed aluminum.

### Incorporation by Reference

U.S. Pat. No. 6,139,913, “Kinetic Spray Coating Method and Apparatus,” and U.S. Pat. No. 6,283,386 “Kinetic Spray Coating Apparatus” are incorporated by reference herein.

### BACKGROUND OF THE INVENTION

A new technique for producing coatings on a wide variety of substrate surfaces by kinetic spray, or cold gas dynamic spray, was recently reported in two articles by T. H. Van Steenkiste et al. The first was entitled “Kinetic Spray Coatings,” published in Surface and Coatings Technology, vol. 111, pages 62-71, Jan. 10, 1999 and the second was entitled “Aluminum coatings via kinetic spray with relatively large powder particles”, published in Surface and Coatings Technology 154, pp. 237-252, 2002. The articles discuss producing continuous layer coatings having high adhesion, low oxide content and low thermal stress. The articles describe coatings being produced by entraining metal powders in an accelerated gas stream, through a converging-diverging de Laval type nozzle and projecting them against a target substrate. The particles are accelerated in the high velocity gas stream by the drag effect. The gas used can be any of a variety of gases including air or helium. It was found that the particles that formed the coating did not melt or thermally soften prior to impingement onto the substrate. It is theorized that the particles adhere to the substrate when their kinetic energy is converted to a sufficient level of thermal and mechanical deformation. Thus, it is believed that the particle velocity must exceed a critical velocity high enough to exceed the yield stress of the particle to permit it to adhere when it strikes the substrate. It was found that the deposition efficiency of a given particle mixture was increased as the inlet air temperature was increased. Increasing the inlet air temperature decreases its density and thus increases its velocity. The velocity varies approximately as the square root of the inlet air temperature. The actual mechanism of bonding of the particles to the substrate surface is not fully known at this time. The critical velocity is dependent on the material of the particle. Once an initial layer of particles has been formed on a substrate subsequent particles bind not only to the voids between previous particles bound to the substrate but also engage in particle to particle bonds. The bonding process is not due to melting of the particles in the particles because the temperature of the particles is always below their melting temperature.

Ceramics find great utilization as insulators and dielectric layers in high power electronic applications. Metalization of these ceramics to provide conductive electrical paths or to provide soldering pads to attach other components has been an ongoing difficulty. One past solution has been to plasma etch the ceramic in a first vacuum chamber in the presence of oxygen and then to quickly apply copper via a sputtering process in a second vacuum chamber. This process is described in U.S. Pat. No. 5,308,463. The process is time consuming and requires several vacuum chambers. Another process uses the high temperature thermal plasma spray method to apply molten copper to a previously roughened ceramic surface. The process operates at a very high temperature that requires cooling of the substrate during the process and results in thermal stress to the ceramic. This process is described in U.S. Pat. No. 5,648,123. One other process has been to place the ceramic surface in direct contact with a molten bath of aluminum to bond the aluminum to the ceramic. This process also requires high temperatures and is difficult to control. The process is described in U.S. Pat. No. 5,965,193.

Given the shortcomings of the prior art methods it would be advantageous to develop a rapid and simple method for applying an aluminum metalization layer to a ceramic substrate. Preferably, the method would not require extensive surface preparation of the ceramic substrate prior to the coating, the method would not require specialized equipment, the method would not cause thermal stress of either the metalization layer or the ceramic substrate, and the method would allow one to vary the thickness of the metalization layer easily.

### SUMMARY OF THE INVENTION

In one embodiment the present invention is a method for aluminum metalization of a ceramic substrate comprising the steps of: providing a ceramic substrate; providing an aluminum particle powder having particles in the size range of from 45 to 90 microns; delivering the aluminum particle powder to a flow of a gas at a rate of from 20 to 60 grams per minute; entraining the aluminum particles into the flow of gas, the gas at a temperature of from 250° to 600° F.; and directing the particle mixture entrained in the flow of gas through a supersonic nozzle having a throat diameter of from 1.8 to 2.8 millimeters towards the ceramic substrate at a stand-off distance of from 10 to 100 millimeters and accelerating the aluminum particles to a velocity of from 435 to 505 meters per second, the aluminum particles adhering to the ceramic substrate to form an aluminum layer having a porosity of less than 2%.

### BRIEF DESCRIPTION OF THE DRAWINGS

The present invention will now be described, by way of example, with reference to the accompanying drawings, in which:

FIG. 1 is a general schematic drawing illustrating a kinetic spray system for performing the method of the present invention;

FIG. 2 is an enlarged cross-sectional view of a kinetic spray nozzle for use in the present invention; and

FIG. 3 is a graph of thermal conductivity versus temperature for a series of kinetic spray applied aluminum layers on a ceramic according to the present invention.

### DESCRIPTION OF THE PREFERRED EMBODIMENT

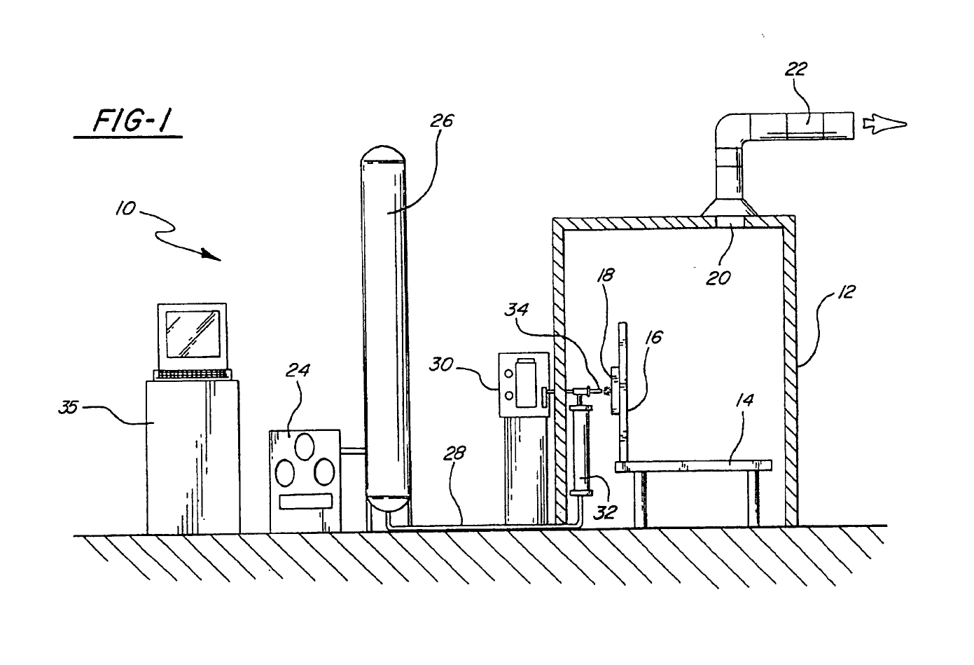

Referring first to FIG. 1, a kinetic spray system according to the present invention is generally shown at 10. System 10 includes an enclosure 12 having a support table 14 or other support means. A mounting panel 16 fixed to the table 14 supports a work holder 18 capable of movement in three dimensions and able to support a suitable workpiece (not shown) of a ceramic substrate to be coated by the present invention. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes an air compressor 24 capable of supplying air pressure up to 3.4 MPa (500 pounds per square inch (psi)) to a high pressure air ballast tank 26. The air ballast tank 26 is connected through a line 28 to both a high pressure powder feeder 30 and a separate air heater 32. The air heater 32 supplies high pressure heated air, the main gas described below, to a kinetic spray nozzle 34.

The movement of the work holder 18 can be adjusted to provide a variety of traverse speeds of the substrate relative to the nozzle 34. Conversely, the system 10 can be designed so the work holder 18 feeds the substrate past the nozzle 34 at an adjustable rate. For the present invention the traverse rate of the substrate relative to the nozzle 34 when applying aluminum to a ceramic substrate preferably ranges from 2.0 to 50.0 millimeters per second, more preferably from 2.5 to 25.0 millimeters per second, and most preferably from 2.5 to 5.0 millimeters per second. When applying a copper powder to a substrate previously coated with aluminum the traverse speed may range outside of these preferred speeds.

The powder feeder 30 mixes particles of a coating powder with unheated high pressure air and supplies the coating powder mixture to a supplemental inlet line 48 of the nozzle 34. In the present invention it is preferred that the aluminum particles used to coat ceramics have an average nominal diameter size range of from 45 to 63 microns or from 63 to 90 microns depending on the particular ceramic being coated. In the present specification and claims the particle sizes refer to the average nominal diameters of the particles. When the present invention is used to coat an aluminum layer previously applied to a ceramic, the copper particles preferably have a particle size of from 63 to 106 microns. A computer control 35 operates to control the pressure of air supplied to the air heater 32, the temperature of the heated main gas exiting the air heater 32, and the feed rate of the powder feeder 30 to the inlet line 48. In the present invention when applying aluminum to a ceramic substrate preferably the aluminum powder is fed at a rate of from 20 to 60 grams per minute, more preferably at a rate of from 35 to 45 grams per minute, and most preferably at a rate of from 38 to 42 grams per minute. When the present system 10 is used to apply other particles, such as copper or copper alloys to a previously applied aluminum layer on a ceramic substrate, the fed rate of the copper or alloy particles may range outside of these ranges.

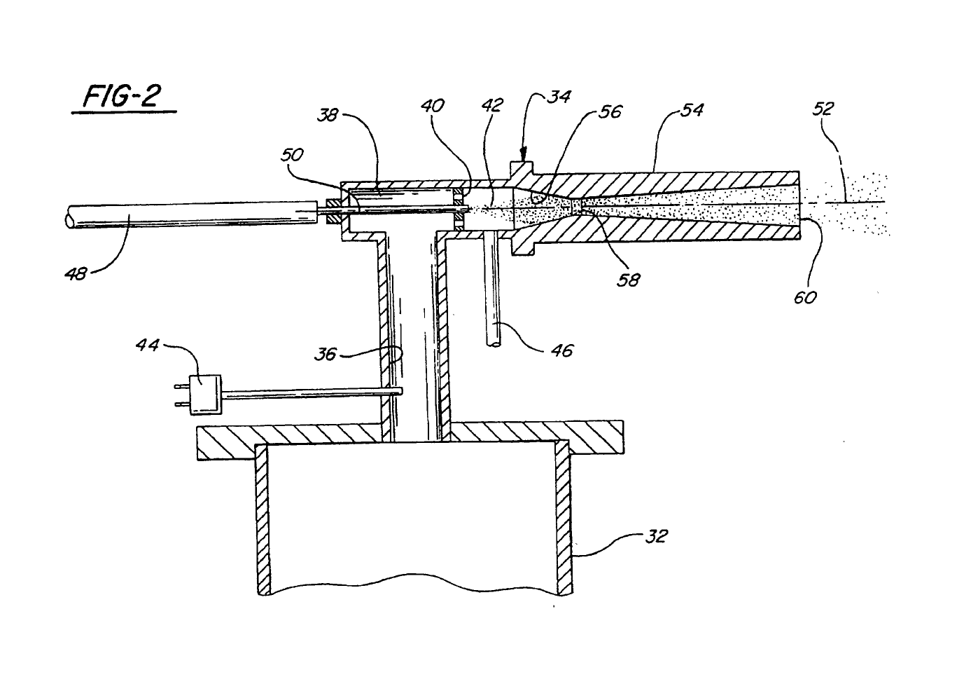

FIG. 2 is a cross-sectional view of the nozzle 34 and its connections to the air heater 32 and the supplemental inlet line 48. A main air passage 36 connects the air heater 32 to the nozzle 34. Passage 36 connects with a premix chamber 38 which directs air through a flow straightener 40 and into a mixing chamber 42. Temperature and pressure of the air or other heated main gas are monitored by a gas inlet temperature thermocouple 44 in the passage 36 and a pressure sensor 46 connected to the mixing chamber 42.

The mixture of unheated high pressure air and coating powder is fed through the supplemental inlet line 48 to a powder injector tube 50 comprising a straight pipe having a predetermined inner diameter. The tube 50 has a central axis 52, which is preferentially the same as the axis of the premix chamber 38. The tube 50 extends through the premix chamber 38 and the flow straightener 40 into the mixing chamber 42.

Mixing chamber 42 is in communication with the de Laval type nozzle 54. The nozzle 54 has an entrance cone 56 that decreases in diameter to a throat 58. Downstream of the throat is an exit end 60. The largest diameter of the entrance cone 56 may range from 10 to 6 millimeters, with 7.5 millimeters being preferred. The entrance cone 56 narrows to the throat 58. The throat 58 may have a diameter of from 1.8 to 2.8 millimeters, with 2.0 millimeters being preferred. The portion of the nozzle 54 from downstream of the throat 58 to the exit end 60 may have a variety of shapes, but in a preferred embodiment it has a rectangular cross-sectional shape. The shape of the exit end 60 determines in part the general shape of the spray pattern that emerges from the exit end 60. Changing the shape of the exit end permits a user of the system to tailor the spray pattern to the particular substrate and application. For example, it may be desirable to have a smaller opening at the exit end 60 when depositing an electrical conductive pathway versus applying a solid layer to a ceramic. At the exit end 60 the nozzle 54 preferably has a rectangular shape with a long dimension of 10 millimeters by a short dimension of 2 millimeters for application of aluminum to ceramic according to the present invention. Preferably the length of the nozzle 54 from the throat 58 to the exit end 60 is 110 millimeters for application of aluminum to a ceramic substrate.

As disclosed in U.S. Pat. Nos. 6,139,913 and 6,283,386 the powder injector tube 50 supplies a particle powder mixture to the system 10 under a pressure in excess of the pressure of the heated main gas from the passage 36. Preferably the pressure of the aluminum particle powder mixture is at least 25 psi greater than the pressure of the heated main gas in the present invention. Preferably, the pressure of the heated main gas is from 275 to 375 psi, with approximately 325 psi being most preferred when applying aluminum to a ceramic substrate. Therefore, preferably the pressure of the aluminum particle powder mixture is from 300 to 400 psi, with approximately 350 psi being most preferred. The nozzle 54 produces an exit velocity of the entrained aluminum particles preferably of from 435 to 505 meters per second. When applying copper or copper alloy particles using the present system 10, the pressures and exit velocities of the copper particles may lie outside of these ranges. The entrained particles gain kinetic and thermal energy during their flow through this nozzle. It will be recognized by those of skill in the art that the temperature of the particles in the gas stream will vary depending on the particle size and the main gas temperature. The main gas temperature is defined as the temperature of heated high-pressure gas at the inlet to the nozzle 54. There is no change in the solid phase of the original particles either by exposure to the heated main gas since their temperature is always below their melting temperature or due to transfer of kinetic and thermal energy, and therefore no change in their original physical properties.

The particles exiting the nozzle 54 are directed toward the surface of the ceramic substrate to coat it. The distance between the exit end 60 and the surface of the ceramic substrate is known as the stand-off distance. This distance influences the deposition efficiency of a given particle powder. When applying aluminum particles to a ceramic according to the present invention the preferred stand-off distance is from 10 to 100 millimeters, more preferably from 10 to 50 millimeters, and most preferably from 15 to 30 millimeters.

Upon striking the ceramic substrate opposite the nozzle 54 the particles flatten into a nub-like structure with an aspect ratio of generally about 5 to 1. Upon impact the kinetic sprayed particles transfer substantially all of their kinetic and thermal energy to the substrate surface and stick if their yield stress has been exceeded. As discussed above, for a given particle to adhere to a substrate it is necessary that it reach or exceed its critical velocity which is defined as the velocity where at it will adhere to a substrate when it strikes the substrate after exiting the nozzle. As discussed above, in the present invention it is preferable that the velocity of the aluminum particles exiting the nozzle 54 be in the range of from 435 to 505 meters per second. This critical velocity is dependent on the material composition of the particle. In general, harder materials must achieve a higher critical velocity before they adhere to a given substrate. Aluminum has a Knoop hardness value of from 70 to 80 while copper has a value above 200 and its alloys have even higher values. Thus, as would be understood by one of ordinary skill in the art, in the present invention one must achieve higher particles velocities to coat with copper and its alloys than for aluminum. It is not known at this time exactly what is the nature of the particle to substrate bond; however, it is believed that a portion of the bond is due to the particles plastically deforming upon striking the substrate.

For the present invention it is preferable that the adhesion strength of the aluminum particles to any ceramic substrate exceed 3 kpsi, which is 20.7 Mpa. This adhesion strength is necessary to withstand the environment wherein these coated ceramics find their use, namely high power electronic applications. The adhesion strength of the coating to the substrate is measured using a Z-axis stud pull machine. The epoxy coated aluminum studs were obtained from Quad Group Inc. The epoxy coated aluminum stud is mounted on the coating with a clamp and the assembly is cured in an oven at 150° C. for one hour. After cooling, the clamp is removed and the stud pull machine is used to register the force required to separate the stud from the coating. Adhesion is a measure of the strength of the bond between the coating and the ceramic substrate. This is in contrast to the cohesion, which is a measure of the strength of the bond between the particles of the coating.

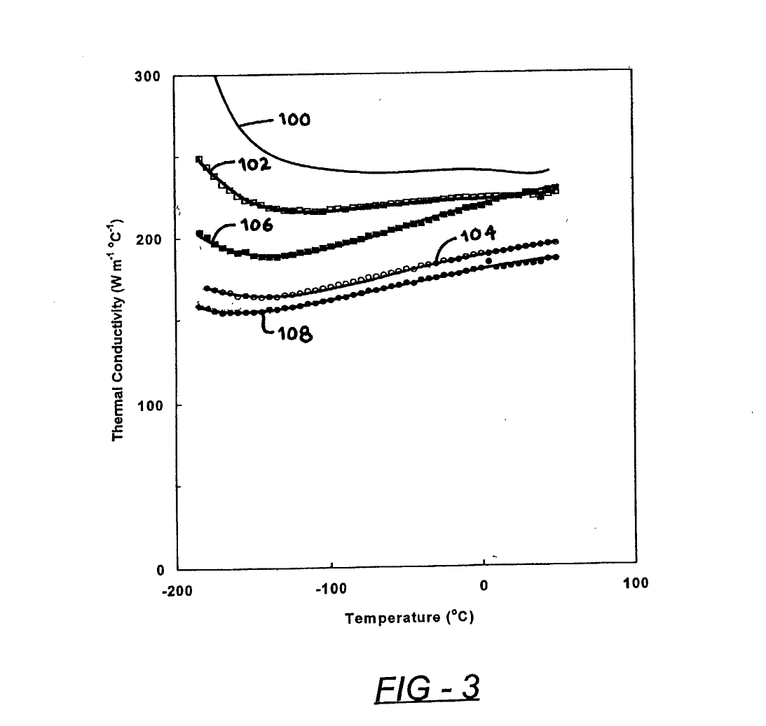

Another advantage of the present invention is that it permits the aluminum layer to have a range of thicknesses depending on the traverse speed, number of passes, and stand-off distance. The present invention permits aluminum layer thicknesses ranging from 10 microns to several centimeters. The thicker layers can be useful if the metalization layer of aluminum is also intended to function as a heat dissipation layer, described below and in FIG. 3. Using the parameters of the present invention the aluminum layer can have similar thermal conductivity as that of bulk pure aluminum. For the present invention the preferred thickness of the aluminum layer ranges from 5 to 500 mils, more preferably from 5 to 100 mils, and most preferably from 5 to 20 mils.

Method of measuring coating porosity

For the present invention it is preferable that the coating porosity of the aluminum metalization layer be less than 2%. The coating porosity was measured using an AccuPyc 1330 Pycnometer. The Pycnometer determines density and volume by measuring the pressure change resulting from displacement of helium by a solid sample in a calibrated volume. By knowing the sample weight, one can determine the density of the sample. To measure porosity the free-standing coated sample is weighed and put into the Pycnometer. On the basis of above description, the Pycnometer gives a volume and the density (ρ1) of the coating. The sample is then soaked in an impregnation sealant (Loctite 990) for several minutes. This anaerobic sealant can penetrate into pores and cracks by capillary action, filling voids as large as 0.005 of an inch, and polymerizes in the absence of air thereby sealing any open pores. Excess sealant is removed from the surface and the sample is returned to the Pycnometer where the volume and density (ρ2) of the sealed coating is determined. The difference in the density (ρ1-ρ2) before and after sealing the open pores gives the open porosity of the sample. As discussed above, for the present invention the coating porosity of the aluminum layer preferably should be less than 2%.

Using the present invention aluminum particles having sizes of from 45 to 63 microns or 63 to 90 were directed against an aluminum substrate, at a traverse speed of 2.5 mm/s, for 6 passes. The spray parameters were as follows: main gas temperature 550° F., main gas pressure 300 psi, powder feeder 30 pressure 350 psi, nozzle throat 58 was 2 millimeters, and the stand-off distance was 19 millimeters. The porosity results are the average of 5 repeated measurements. The coating porosity of the aluminum layer created using particles of 45 to 63 microns was 1.30. The coating porosity of the aluminum layer created using particles of 63 to 90 microns was 1.75. Effect of traverse speed and post kinetic spray annealing on bond strength

In the present invention it was discovered that the traverse speed was important. In the present specification the traverse speed means movement of one of the ceramic substrate or the nozzle 34 relative to the other, whether the nozzle 34 or the ceramic substrate is being moved. Traverse speed was important for obtaining good deposition and bond strength of the aluminum to the ceramic. In addition, it was found that a post deposit annealing step at the appropriate temperature dramatically increased the bond strength of the aluminum to ceramics. To evaluate this two ceramics, alumina (Al₂O₃) and aluminum nitride (AIN), were coated with aluminum powders having size ranges of from 45 to 63 microns or 63 to 90 microns at the traverse speeds noted in Table 1 below. The adhesion results are the average of 4 to 5 repeated measurements. The coatings processed are the result of 6 passes of the nozzle 34 over the ceramic sample. The main gas temperature was 550° F., the main gas pressure was 300 psi, the powder feeder 30 pressure was 350 psi, the nozzle throat 58 was 2 millimeters, and the stand-off distance was 19 millimeters. Adhesion was tested as described above. The post-deposit annealing was conducted in an atmosphere of air at 550° C. We have found in other experiments that the atmosphere may comprise air, argon, nitrogen, or other inert gases. In addition, the annealing temperature preferably ranges from 400 to 575° C., with 500 to 550° C. being most preferred. Preferably the annealing step is carried out for a period of time of from 30 minutes to 5 hours, and more preferably from 30 minutes to two hours. The results demonstrate the importance of traverse speed and particle size on adhesion strength. The results further demonstrate the positive effect of post-deposit annealing on adhesion strength. As noted above, for the present invention it is preferable that the adhesion strength of the aluminum layer to the ceramic substrate be in excess of 3.0 kpsi to tolerate the thermal cycling encountered in high power electronic applications. The results demonstrate that the traverse speed more preferably ranges from 2.5 to 25 millimeters/second and most preferably from 2.5 to 5.0 millimeters/second.

TABLE 1

| Powder | | Traverse | Adhesion, | Adhesion | Adhesion |
|---|---|---|---|---|---|
| size, | | speed, | kpsi, as | post 1 hour | post 5 hours |
| microns | Substrate | mm/sec | deposited | at 550° C. | at 550° C. |
| 45-63 | Alumina | 2.5 | 2.87 | 7.70 | |
| 45-63 | Alumina | 5.0 | 1.43 | 6.27 | |
| 45-63 | Alumina | 25.0 | 1.24 | 7.02 | |
| 45-63 | Alumina | 50.0 | 2.41 | 4.15 | 6.42 |
| 45-63 | AlN | 2.5 | 2.41 | 6.87 | |
| 45-63 | AlN | 5.0 | 4.30 | 6.23 | |
| 45-63 | AlN | 25.0 | 1.40. | 3.00 | 3.32 |
| 45-63 | AlN | 50.0 | 0.00 | 0.50 | 2.79 |
| 63-90 | Alumina | 2.5 | 4.25 | 8.69 | |
| 63-90 | Alumina | 5.0 | 3.85 | 7.18 | |
| 63-90 | Alumina | 25.0 | 2.38 | 7.36 | |
| 63-90 | Alumina | 50.0 | 1.81 | 3.25 | 3.51 |
| 63-90 | AlN | 2.5 | 5.61 | 6.87 | |
| 63-90 | AlN | 5.0 | 1.58 | 3.47 | 8.84 |
| 63-90 | AlN | 25.0 | 0.2 | 1.92 | 0.75 |

Effect of substrate temperature on adhesion of kinetically sprayed aluminum

In the present invention it was found that the temperature of the ceramic substrate effected the adhesion strength of the aluminum on a variety of substrates. The aluminum powder used was sieved to a size range of 63 to 90 microns. The results are from a single pass at a traverse speed of 25 millimeters per second. The main gas temperature was 550° F., the main gas pressure was 300 psi, the powder feeder 30 pressure was 350 psi, the nozzle throat 58 was 2 millimeters, and the stand-off distance was 19 millimeters. The results are presented in Table 2 below. Increasing the substrate temperature dramatically increased the deposition efficiency as seen in the increase in thickness of a single pass with an increase in the substrate temperature. Also, increasing the substrate temperature dramatically increased the adhesion strength of the aluminum layer to the substrate. Preferably the substrate is heated to from 50 to 200 degrees Celsius prior to applying the aluminum coating.

TABLE 2

| | Substrate temp. | Adhesion strength | |
|---|---|---|---|
| Substrate | Celsius | (Kpsi) | Thickness (mills) |
| Aluminum plate | 27 | 0.3 | 9 |
| Aluminum plate | 100 | 0.5 | 15 |
| Aluminum plate | 200 | 2.4 | 22 |
| Alumina | 27 | 0.28 | 16 |
| Alumina | 100 | 1.15 | 20 |
| Alumina | 200 | 3.6 | 28 |

Thermal conductivity of kinetically sprayed aluminum versus bulk aluminum

FIG. 3 shows plots of temperature versus thermal conductivity of applied aluminum layers to an aluminium substrate. The coating was removed from the substrate and a rectangular block-shaped sample was prepared for measuring thermal conductivity. The figure also shows the thermal conductivity of a pure aluminum polycrystal at these temperatures for comparison. Measuring the thermal conductivity in a direction parallel to the spray direction shows the effect of peening by the sprayed powder on the thermal conductivity, while measuring the thermal conductivity perpendicular to the spray direction shows the effect of stacking. The spray parameters were: aluminum particles sized 63 to 90 microns, main gas temperature 550° F., main gas pressure 300 psi, powder feeder 30 pressure was 350 psi, nozzle throat 58 is 2 millimeters, stand-off distance was 19 millimeters, traverse speed 2.5 mm's, number of passes 25, and the substrate was aluminum. In FIG. 3 the effect of post-deposition annealing for 1 hour at 550° C. in air is also shown. In FIG. 3 line 100 represents the thermal conductivity of a pure aluminum polycrystal. Line 102 represents the thermal conductivity measured perpendicular to the spray direction after the annealing step. Line 104 represents the thermal conductivity measured parallel to the spray direction after the annealing step. Line 106 represents the thermal conductivity measured perpendicular to the spray direction before the annealing step. Line 108 represents the thermal conductivity measured parallel to the spray direction before the annealing step. The results demonstrate that the annealing step increases the thermal conductivity bringing it closer to that of pure aluminum. The results demonstrate that aluminum metalization layers made according to the present invention can function in a thermal conductivity manner that is nearly the same as pure aluminum.

The present invention also enables for rapid addition of copper or copper alloy soldering pads to the aluminum metalization layer to enable chip mounting and/or wire bonding. A user having two powder feeders 30 can easily switch the powder delivered to the nozzle 34 to the copper particles once the aluminum layer has been formed. Altering the system 10 parameters as necessary to achieve a high quality copper or copper alloy coating is within the skill of one in the art of kinetic spray.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method for aluminum metalization of a ceramic substrate comprising the steps of:
a) providing a ceramic substrate;
b) providing an aluminum particle powder having particles in the size range of from 45 to 90 microns;
c) delivering the aluminum particle powder to a flow of a gas at a rate of from 20 to 60 grams per minute;
d) entraining the aluminum particles into the flow of gas, the gas at a temperature of from 250° to 600° F.; and
e) directing the particle mixture entrained in the flow of gas through a supersonic nozzle having a throat diameter of from 1.8 to 2.8 millimeters towards the ceramic substrate at a stand-off distance of from 10 to 100 millimeters with a traverse speed of from 2.5 to 50 millimeters/second and accelerating the aluminum particles to a velocity of from 435 to 505 meters per second, the aluminum particles adhering to the ceramic substrate to form an aluminum layer having a porosity of less than 2% and an adhesion of greater than 3 kpsi on the ceramic substrate.

2. The method of claim 1, wherein step a) comprises providing a ceramic surface comprising one of alumina or aluminum nitride.

3. The method of claim 1, wherein step b) comprises providing an aluminum powder having particles in the size range of from 45 to 63 microns.

4. The method of claim 1, wherein step b) comprises providing an aluminum powder having particles in the size range of from 63 to 90 microns.

5. The method of claim 1, wherein step c) comprises delivering the aluminum particle powder to the gas flow at a rate of from 35 to 45 grams per second.

6. The method of claim 1, wherein step c) comprises delivering the aluminum particle powder to the gas flow at a rate of from 38 to 42 grams per second.

7. The method of claim 1 wherein step c) further comprises providing the flow of the gas at a pressure of from 275 to 375 pounds per square inch and the aluminum particle powder at a pressure that is at least 25 pounds per square inch greater than the pressure of the flow of the gas.

8. The method of claim 7, comprising providing the flow of the gas at a pressure of 300 pounds per square inch and the aluminum particle powder at a pressure of 350 pounds per square inch.

9. The method of claim 1, wherein step d) comprises providing the flow of gas at a gas temperature of 550° F.

10. The method of claim 1, wherein step e) comprises directing the particle mixture entrained in the flow of gas through a supersonic nozzle having a throat diameter of 2.0 millimeters.

11. The method of claim 1, wherein step e) comprises directing the particle mixture through the supersonic nozzle towards the ceramic substrate at a stand-off distance of from 10 to 50 millimeters.

12. The method of claim 1, wherein step e) comprises directing the particle mixture through the supersonic nozzle towards the ceramic substrate at a stand-off distance of from 15 to 30 millimeters.

13. The method of claim 1, wherein step e) further comprises directing the particle mixture through the supersonic nozzle towards the ceramic substrate to form an aluminum layer on the ceramic substrate of from 10 microns to 2 centimeters in thickness.

14. The method claim 1, wherein step e) further comprises using a traverse speed of from 2.5 to 25.0 millimeters/second while directing the particle mixture entrained in the flow of gas through the supersonic nozzle towards the ceramic substrate

15. The method claim 1, wherein step e) further comprises using a traverse speed of from 2.5 to 5.0 millimeters/second while directing the particle mixture entrained in the flow of gas through the supersonic nozzle towards the ceramic substrate

16. The method of claim 1, wherein step e) further comprises annealing the ceramic substrate having the aluminum layer at a temperature of from 400 to 575° F. for a period of time of from 30 minutes to 5 hours.

17. The method of claim 1, wherein step e) further comprises annealing the ceramic substrate having the aluminum layer at a temperature of from 400 to 575° F. for a period of time of from 30 minutes to 2 hours.

18. The method of claim 1, wherein step e) further comprises annealing the ceramic substrate having the aluminum layer at a temperature of from 450 to 550° F. for a period of time of from 30 minutes to 5 hours.

19.) The method of claim 1, wherein step a) further comprises heating the ceramic substrate to a temperature of from 50 to 200 degrees Celsius prior to directing the entrained particle mixture towards the ceramic substrate to form an aluminum layer.

20. The method of claim 1, further comprising after step e) the steps of
a) providing a particle powder of copper or a copper alloy having particles in the size range of from 45 to 106 microns;
b) entraining the into a flow of a gas, the gas at a temperature of from 250° to 1200° F.; and
e) directing the particle mixture entrained in the flow of gas through a supersonic nozzle having a throat diameter of from 1.8 to 2.8 millimeters towards the aluminum layer on the ceramic substrate at a stand-off distance of from 10 to 100 millimeters and accelerating the particles to a velocity of from 400 to 800 meters per second, the particles adhering to the aluminum layer on the ceramic substrate to form a layer of copper or copper alloy.
